(19) United States
(12) Patent Application Publication
(10) Pub. No.: US 2004/0105547 A1
(43) Pub. Date: Jun. 3, 2004

(54) Software protection

(76) Inventor: John Aram Safa, Nottingham (GB)

Correspondence Address: SMITH-HILL AND BEDELL, 12670 N W BARNES ROAD, SUITE 104, PORTLAND, OR, 97229

(21) Appl. No.: 10/666,411

(22) Filed: Sep. 19, 2003

(30) Foreign Application Priority Data
Sep. 21, 2002 (GB) 0221984.8

(51) Int. Cl. H04K 1/00

(52) U.S. Cl. 380/270

(57) ABSTRACT

Software on a wireless device is protected by an arrangement in which an identifier is derived from the hardware of the device on which the software is to be run. The identifier is sent to a server which derives a derived identifier by applying a function g to the identifier. The derived identifier is returned to the device which executes a function h. Function h is the inverse of function g. Comparison with the original identifier thus confirms that operation of the software is authorised. In the event that it is not, the server does not send back a derived identifier.

### BACKGROUND OF THE INVENTION

The present invention relates to software protection arrangements.

Protection arrangements are necessary for software to prevent unlicensed copies of commercial software being made and distributed among users. This deprives the proprietor of the software from legitimate income from the sale of licences. In particular, it is envisaged that a particular risk of illicit copying arises in relation to applications provided commercially for execution on wireless devices, such as mobile phones.

### SUMMARY OF THE INVENTION

The present invention provides a software protection arrangement for protecting software to be run on a wireless device operable for communication over a wireless network, the arrangement including identifying means operable to create an identifier which characterises the device on which the protected software is to be run; authorisation means operable to receive an identifier created by the identifying means to execute a predetermined function on a received identifier to form a derived identifier, execution of the predetermined function being conditional upon verification of a condition required for authorisation of the use of the software; and the arrangement further comprising enabling means operable to enable execution of the protected software only when in receipt of an enabling identifier from the authorisation means, the derived identifier serving as an enabling identifier in the event that the derived identifier has been derived by the predetermined function from the identifier of the device on which the protected software is to be run.

The enabling means may be operable to apply a function to the derived identifier to recover the identifier from which the derived identifier was derived, and to compare the recovered identifier with the identifier created by the identifying means, and to enable or disable execution of the software in accordance with the result of the comparison.

Preferably the protected software is in encrypted form requiring decryption by at least one decryption key for successful execution, the enabling means including decryption means operable to execute a process which includes decryption of the encrypted code, and to use the derived identifier as a key for the process.

Preferably the predetermined function is a function of at least two variables, a received identifier forming one of the variables, and the other variable being a confidential decryption key stored at the authorisation means, and wherein the enabling means is operable to perform a preliminary step to execute a second predetermined function of at least two variables, including the identifier and the derived identifier, to recover the confidential decryption key for use as a decryption key in decrypting the encrypted code.

Preferably the identifier further includes information characterising the protected software, and the authorisation means is operable to select a confidential decryption key corresponding with the identified software.

Preferably the identifier is derived from information which identifies hardware and/or software present at the device.

The authorisation means may be operable to effect a financial transaction or credit check before allowing execution of the predetermined function.

Preferably, the identifying means is operable to create an identifier as aforesaid on each occasion protected software is to run on the device.

Preferably the identifying means transmits identifiers to the authorisation means, over the wireless network.

The authorisation means may be operable to transmit derived identifiers to the enabling means by means of the wireless network.

The enabling means and/or the identifying means are preferably provided by software elements associated with the protected software.

In a second aspect, the invention provides an arrangement for use in protecting software to be run on a wireless device operable for communication over a wireless network, the arrangement including identifying means operable to create an identifier which characterises the device on which the protected software is to be run; enabling means operable to receive a derived identifier derived by authorisation means from the identifier created by the identifying means, and the enabling means being further operable to enable execution of the software only when in receipt of an enabling identifier, the derived identifier serving as an enabling identifier in the event that the derived identifier has been derived by the predetermined function from the identifier of the device on which the software is to be run.

The enabling means may be operable to apply a function to the derived identifier to recover the identifier from which the derived identifier was derived, and to compare the recovered identifier with the identifier created by the identifying means, and to enable or disable execution of the software in accordance with the result of the comparison.

Preferably the protected software is in encrypted form requiring decryption by at least one decryption key for successful execution. The enabling means may include decryption means operable to execute a process which includes decryption of the encrypted code, and to use the derived identifier as a key for the process.

Preferably the derived identifier is derived by a predetermined function which is a function of at least two variables, a received identifier forming one of the variables, and other variable being a confidential decryption key stored at the authorisation means, and wherein the enabling means is operable to perform a preliminary step to execute a second predetermined function of at least two variables, including the identifier and the derived identifier, to recover the confidential decryption key for use as a decryption key in decrypting the encrypted code.

Preferably the identifier further includes information characterising the protected software, whereby the authorisation means may operate to select a confidential decryption key corresponding with the identified software.

Preferably the identifier is derived from information which identifies hardware and/or software present at the device.

Preferably, the identifying means is operable to create an identifier as aforesaid on each occasion protected software is to run.

The enabling means and/or the identifying means are preferably provided by software elements associated with the protected software.

In a third aspect, the invention provides an arrangement for use in protection of software to be run on a wireless device operable for communication over a wireless network, the arrangement including authorisation means operable to receive an identifier characterising a device on which protected software is to be run, and the authorisation means being operable to execute a predetermined function on a received identifier to form a derived identifier, execution of the predetermined function being conditional upon verification of a condition required for authorisation of the use of the software; and to provide the derived identifier to allow enabling means to enable execution of the software only when in receipt of an enabling identifier which is a derived identifier derived from the identifier of the device on which the software is to be run.

The predetermined function may be a function of at least two variables, a received identifier forming one of the variables, and another variable being a confidential decryption key stored at the authorisation means, wherein a preliminary step is required upon receipt of a derived identifier by enabling means, to execute a second predetermined function of at least two variables, including the identifier and the derived identifier, to recover the confidential decryption key for use as a decryption key in decrypting an encrypted form of the protected software.

The identifier may include information characterising the protected software, the server being operable to select a confidential decryption key corresponding with the identified software.

The authorisation means is preferably operable to effect a financial transaction or credit check before allowing execution of the predetermined function.

The invention also provides computer software which, when installed on one or more computer systems, is operable to provide a software protection arrangement as set out above.

The invention also provides a carrier medium for software as defined in the previous paragraph. The medium may be a memory device or a transmission medium on which the software is carried by a propagating signal. The invention also provides a signal propagating as aforesaid. The invention also provides a signal propagating on a transmission medium and carrying an identifier or derived identifier of a software protection arrangement as defined above.

The invention also provides a method of protecting software to be run on a wireless device operable for communication over a wireless network including the steps of creating an identifier which characterises the device on which the protected software is to be run; receiving an identifier and executing a predetermined function on a received identifier to form a derived identifier, execution of the predetermined function being conditional upon verification of a condition required for authorisation of the use of the software; and enabling execution of the protected software only in response to an enabling identifier, the derived identifier serving as an enabling identifier in the event that the derived identifier has been derived by the predetermined function from the identifier of the device on which the protected software is to be run.

A function may be applied to the derived identifier to recover the identifier from which the derived identifier was derived, and to compare the recovered identifier with the identifier created by the identifying means, and to enable or disable execution of the software in accordance with the result of the comparison.

Preferably the protected software is in encrypted form requiring decryption by at least one decryption key for successful execution, the enabling step including a decryption step which includes decryption of the encrypted code, the derived identifier being used as a key for the decryption step.

Preferably the predetermined function is a function of at least two variables, a received identifier forming one of the variables, and the other variable being a confidential decryption key, the enabling step including a preliminary step to execute a second predetermined function of at least two variables, including the identifier and the derived identifier, to recover the confidential decryption key for use as a decryption key in decrypting the encrypted code.

Preferably the identifier is created to include information characterising the protected software, and the confidential decryption key is selected according to the software identified.

Preferably the identifier is derived from information which identifies hardware and/or software present at the machine.

### BRIEF DESCRIPTION OF THE DRAWINGS

Preferably a financial transaction or credit check is effected before allowing execution of the predetermined function.

Embodiments of the present invention will now be described in more detail, by way of example only, and with reference to the accompanying drawings, in which:

FIG. 1 illustrates a wireless device by means of which the present invention may be implemented and on which protected software is to be run;

FIG. 2 illustrates part of a server with which the wireless device of FIG. 1 communicates during implementation of the invention;

FIGS. 3a and 3b illustrate simplified sequences of steps for enabling execution of the protected software; and

FIGS. 4a and 5b respectively illustrate the locations at which the various steps of the sequences of FIGS. 4a and 4b, respectively, take place.

### DETAILED DESCRIPTION

Device on which the Software is to be Run

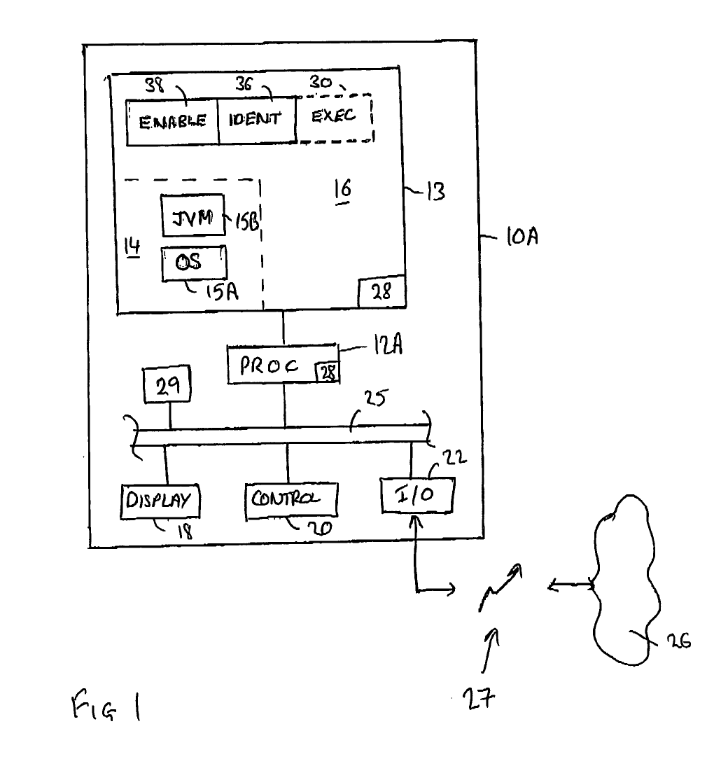

FIG. 1 illustrates a wireless device 10A operable for communication over a wireless network, and by means of which the present invention may be implemented.

In FIG. 1, the wireless device 10A includes a central processor 12A with associated memory 13, divided between permanent memory 14 and temporary memory 16. The permanent memory 14 contains an operating system 15A and may also contain application software such as a JAVA Virtual Machine (JVM) 15B. The temporary memory may contain application software, such as a JAVA application. It is these applications which are vulnerable to unlicensed copying, which the present invention seeks to prevent. A display screen 18 and keyboard 20 are provided for use by a user. Input and output arrangements are provided at 22, in the form of a wireless transceiver device. Communication between the components described above is provided by a data bus 25. The transceiver 22 connects to an external wireless communication network 26, as indicated at 27.

A skilled reader will have no difficulty in obtaining appropriate hardware and software to form a wireless device of the type described above and suitable for implementing the present invention, once the description set out below has been fully understood.

Various unique identifiers are present within the device 10A. For example the processor 12A and memory 13 may each have associated with it a unique identifier, which enables the component to be distinguished from other otherwise identical hardware components. The identifier 28 will be permanently built into the component during manufacture. In addition, the wireless device will have identifiers 29 which are unique to it and/or to the owner or authorised user of it. One such identifier 29 is schematically illustrated as being in communication over the data bus 25. Alternative arrangements could be used. Examples of identifiers 29 include SIM cards, IMI numbers, etc.

The memory 13 stores a copy of the protected software 30, ready for execution, under control of the security arrangements. The copy 30 may have been downloaded over the wireless network 26. The temporary area 16 is shown as containing three software elements, namely an identifying module 36, an enabling module 38 and an executable form of the software 30. The executable form 30 is shown in broken lines to indicate that its availability is dependent on the security arrangements being described.

Server

FIG. 2 illustrates an authorisation arrangement embodied in this example as a server 10B remote from the device 10A, and in communication with the device 10A by means of the wireless network 26. The server may be controlled by the network provider or by a service provider. The server 10B is preferably constructed according to a general purpose computer architecture, illustrated in simplified form, such as an IBM compatible personal computer (PC) architecture. Many components of the server 10B correspond with components shown in FIG. 2, and bear the corresponding numeral and the suffix B. The memory of the server 10B is provided as two separate devices. Main memory 14B is provided as RAM. Auxiliary memory 16B is provided in the form of a hard disc drive.

Within the server, the RAM 14B is shown as containing two software modules in addition to an operating system 32B, namely a module 42 operable to execute a predetermined function, and a finance or credit checking module 44.

The hard disc 16B may include the data of one or more databases for access by the modules 42, 44 as required, as will become apparent.

In this example, the server operates to execute automatically the authorisation functions. In alternative embodiments, the authorisation arrangement can be embodied in other ways. For example, software modules could be provided within the device 10A to perform the authorisation functions to be described. Alternatively, the authorisation functions could be provided remotely, but not automatically, or semi-automatically. For example, communication between the device 10A and the authorisation arrangement could involve steps taken by a human operator, such as a telephone voice message, or the authorisation arrangement could involve a human operator operating a machine or otherwise providing the authorisation functions.

Functions of the Modules

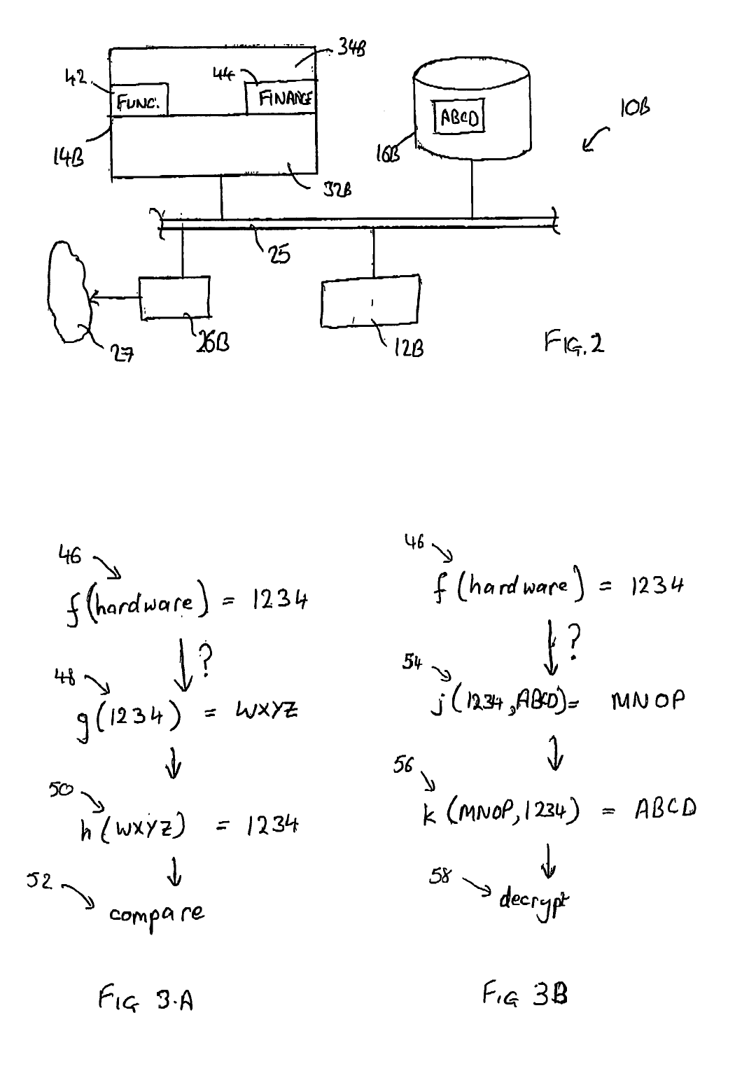

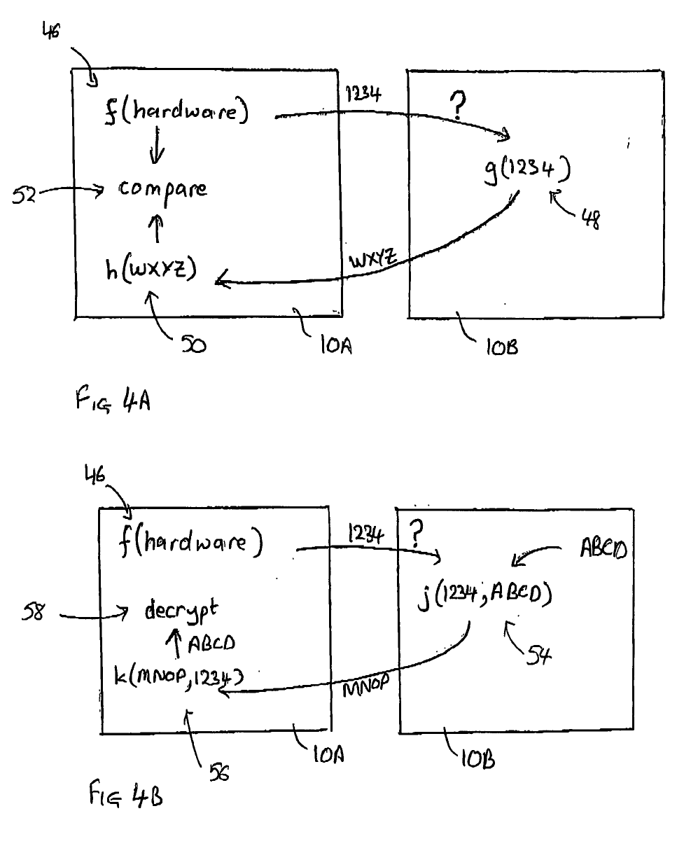

The functions of the various software modules can be illustrated as a sequence of steps as shown in FIGS. 3a and 3b. FIGS. 4a and 4b illustrate more graphically the location at which these steps are implemented.

In both embodiments, the identifying module 36 executes, preferably on each occasion software is to be run, to create an identifier which includes information characterising the device on which the software is to be run. This identifier is created by interrogating various components of the device 10A to determine their component identifiers 28 and/or obtaining device identifiers 29, and combining one or more of these identifiers to create an identifier which includes information characterising the device 10A. The identifier may be created by combining one or more identifiers 28, 29 by an algorithm of any desired complexity. This algorithm is illustrated at 46 as f (hardware) to indicate a function applied to hardware and device identifiers 28, 29. In FIG. 3a, function f (hardware) returns the value 1234. It is to be understood that this represents only an example. The value returned will depend on the identifiers 28, 29 forming the arguments of the function, and thus will depend on the device on which the module 36 is being executed (and in particular, will preferably depend on the SIM or IMI unique identifiers which are present). The value returned could be alpha-numeric or a binary string or recorded in other machine readable form and the length of the identifier could vary from that shown, according to the nature of the algorithm f.

In this example, the identifier 1234 is sent by means of the transceiver 22 over the wireless network 26 to the server 10B. Alternatively, the identifier could be sent internally of the device 10A to the authorising means, or externally by human intervention. The authorisation means, in this case the server 10B, receives the identifier from the device 10A and operates on it by means of the predetermined function module 42. In this example, the module 42 applies a function illustrated as g, at 48, to return a value derived from the received identifier (1234 in this example) and here called the derived identifier. In this example, and purely for purposes of example, the derived identifier is shown as WXYZ. Thus, g (1234)=WXYZ.

It will be clearly apparent that the value of the derived identifier depends on the value of the received identifier, and on the nature of the function g.

Prior to execution of function g, verification is required in order to ensure that it is appropriate to authorise the protected software to be used. Verification involves the verification of a condition required for authorisation. For example, the condition may be financial, in which case, the finance or credit check module 44 is called. This serves to identify the device 10A from the received identifier, perhaps in conjunction with a database in the hard disc 16B. A financial transaction may then be executed, such as a debit to a billing account held by the user with the network provider or service provider, or a credit card account, or a credit check may be made before passing control back to the function module 42 for execution of the function 9. Alternatively, the module 44 may verify that the protected software is authorised for use on the identified device.

The use of a finance or credit check is optional and may not always be required or desirable. However, the use of a module 44 will always be required in order to effect verification of a condition, and only to authorise execution of the function g in the event that the result of verification is positive. Consequently, the ? symbol is associated with the connections between the functions f and g in FIGS. 3A and 4A.

The derived identifier WXYZ is transmitted back to the device 10A, preferably over the wireless network 26.

The derived identifier serves as input to the enabling module 38 which, in this example, executes a further function h on the derived identifier, at 50. The function h is devised to recover the identifier 28 from the derived identifier. Thus, h (WXYZ)=1234. Function h is the inverse of function g.

The enabling module 38 concludes by making a comparison at 52 between the result of function h applied to the derived identifier, and the identifier created by the module 36 and sent to the machine 10B. These will be identical in the event that the identifier and derived identifier have been sent from and to the same machine, and that the sending of a derived identifier has been authorised by the module 44.

If use of the software is not authorised, no derived identifier will be received. If a received identifier is used with a different device (such as one to which the software 30 has been illicitly copied), the comparison will fail. The enabling module 38 is programmed to prevent execution of the software 30 in the absence of a derived identifier, or the failure of the comparison. The software 30 is thus protected from execution except on a single authorised device.

Second Embodiment

In this example, the first step at 46 is again to create an identifier by interrogating the identifier 28 of the constituent components of the device 10A, the SIM or IMI unique identifers 29, etc. Again, this is illustrated as returning the value 1234. This step is executed within the device 10A by the identifying module 36. The identifier is sent to the authorisation means, again in the form of a server 10B, by means of the transceiver 22, over the wireless network 26.

In this example, the software 30 is held in encrypted form in the memory 13, and the enabling module 38 is required to decrypt by using a decryption key. The decryption key is created as follows.

At the server 10B, the identifier created by the module 36 is received and used at 54 as a variable for a predetermined function j. Function j is authorised to execute only upon verification of a required condition, such as a satisfactory financial transaction or check, as described above. Consequently, the ? symbol is again used in FIGS. 3B and 4B.

Function j is a function having at least two variables. In this example, the second variable is shown as ABCD, which is a confidential decryption key stored at the server, in the hard disc 16B.

In a simple form of this example, the same confidential decryption key will be used on each occasion. In a more complex arrangement, a range of confidential decryption keys may be available to the machine 10B. For example, the received identifier may further include information characterising the protected software, the module 42 selecting a confidential decryption key corresponding with the software identified by the identifier. Thus, all encrypted copies of a particular application could be associated with the same confidential decryption key, there being a different confidential decryption key associated with all encrypted copies of a different application.

Having selected the appropriate confidential decryption key ABCD, the module 42 executes function j, returning the value MNOP, i.e. j (1234, ABCD)=MNOP.

MNOP forms the derived identifier, being derived, in part, from the identifier 1234. The derived identifier MNOP is sent back to the device 10A.

The derived identifier MNOP is received by the enabling module 38 which, in this example, first executes a preliminary step at 56 by applying a second predetermined function k to the received identifier. Function k is a function of at least two variables, one being the derived identifier MNOP, and the other being the identifier created by the module 36. Function k is chosen such that by applying this to the variables MNOP and 1234, the confidential decryption key supplied within the computer 10B is returned. Thus, k (MNOP, 1234)=ABCD.

The value returned from function k is then used as a decryption key at 58 by the enabling module 38, to decrypt the software copy at 30, for execution at 40.

If use of the protected software is not authorised for the device sending the identifier, no derived identifier is returned and the software cannot be decrypted. If function k is executed on a device which is not the device from which the derived identifier MNOP was ultimately derived, the identifier used will be incorrect and the result of function k will not be the correct value ABCD. Consequently, the decryption of the software 30 will fail. Similarly, if the derived identifier has been derived from the incorrect confidential decryption key, decryption will again fail.

It is also to be noted that the decryption code ABCD has been made available within the device 10A for decryption, but without being sent across the communication network. In effect, an encrypted encryption key is sent, so that these two layers of encryption improve the protection provided to the software 30.

Alternative Arrangements

It will be readily apparent to the skilled reader that many alternatives can be devised for the arrangements described above. The various functions which have been described could be of arbitrarily great complexity, subject to the availability of appropriate processing power. The various functions described can be implemented in various combinations of hardware and software. Many different examples of appropriate technologies could be chosen for the hardware items described.

The various software modules described above can be carried on a carrier medium prior to installation, such as on a memory device or as a signal propagating on a transmission medium.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A software protection arrangement for protecting software to be run on a wireless device operable for communication over a wireless network, the arrangement including:
identifying means operable to create an identifier which characterises the device on which the protected software is to be run;
authorisation means operable to receive an identifier created by the identifying means to execute a predetermined function on a received identifier to form a derived identifier, execution of the predetermined function being conditional upon verification of a condition required for authorisation of the use of the software;
and the arrangement further comprising enabling means operable to enable execution of the protected software only when in receipt of an enabling identifier from the authorisation means, the derived identifier serving as an enabling identifier in the event that the derived identifier has been derived by the predetermined function from the identifier of the device on which the protected software is to be run.

2. The arrangement of claim 1, wherein the enabling means is operable to apply a function to the derived identifier to recover the identifier from which the derived identifier was derived, and to compare the recovered identifier with the identifier created by the identifying means, and to enable or disable execution of the software in accordance with the result of the comparison.

3. The arrangement of claim 1, wherein the protected software is in encrypted form requiring decryption by at least one decryption key for successful execution, the enabling means including decryption means operable to execute a process which includes decryption of the encrypted code, and to use the derived identifier as a key for the process.

4. The arrangement of claim 1, wherein the predetermined function is a function of at least two variables, a received identifier forming one of the variables, and the other variable being a confidential decryption key stored at the authorisation means, and wherein the enabling means is operable to perform a preliminary step to execute a second predetermined function of at least two variables, including the identifier and the derived identifier, to recover the confidential decryption key for use as a decryption key in decrypting the encrypted code.

5. The arrangement of claim 4, wherein the identifier further includes information characterising the protected software, and the authorisation means is operable to select a confidential decryption key corresponding with the identified software.

6. The arrangement of claim 1, wherein the identifier is derived from information which identifies hardware and/or software present at the device.

7. The arrangement of claim 1, wherein the authorisation means is operable to effect a financial transaction or credit check before allowing execution of the predetermined function.

8. The arrangement of claim 1, wherein the identifying means is operable to create an identifier as aforesaid on each occasion protected software is to run on the device.

9. The arrangement of claim 1, in which the identifying means transmits identifiers to the authorisation means, over the wireless network.

10. The arrangement of claim 9, wherein the authorisation means is operable to transmit derived identifiers to the enabling means by means of the wireless network.

11. The arrangement of claim 1, wherein the enabling means and/or the identifying means are provided by software elements associated with the protected software.

12. An arrangement for use in protecting software to be run on a wireless device operable for communication over a wireless network, the arrangement including:
identifying means operable to create an identifier which characterises the device on which the protected software is to be run;
enabling means operable to receive a derived identifier derived by authorisation means from the identifier created by the identifying means, and the enabling means being further operable to enable execution of the software only when in receipt of an enabling identifier, the derived identifier serving as an enabling identifier in the event that the derived identifier has been derived by the predetermined function from the identifier of the device on which the software is to be run.

13. The arrangement of claim 12, wherein the enabling means are operable to apply a function to the derived identifier to recover the identifier from which the derived identifier was derived, and to compare the recovered identifier with the identifier created by the identifying means, and to enable or disable execution of the software in accordance with the result of the comparison.

14. The arrangement of claim 13, wherein the protected software is in encrypted form requiring decryption by at least one decryption key for successful execution.

15. The arrangement of claim 14, wherein the enabling means include decryption means operable to execute a process which includes decryption of the encrypted code, and to use the derived identifier as a key for the process.

16. The arrangement of claim 12, wherein the derived identifier is derived by a predetermined function which is a function of at least two variables, a received identifier forming one of the variables, and other variable being a confidential decryption key stored at the authorisation means, and wherein the enabling means is operable to perform a preliminary step to execute a second predetermined function of at least two variables, including the identifier and the derived identifier, to recover the confidential decryption key for use as a decryption key in decrypting the encrypted code.

17. The arrangement of claim 16, wherein the identifier further includes information characterising the protected software, whereby the authorisation means may operate to select a confidential decryption key corresponding with the identified software.

18. The arrangement of claim 12, wherein the identifier is derived from information which identifies hardware and/or software present at the device.

19. The arrangement of claim 12, wherein the identifying means is operable to create an identifier as aforesaid on each occasion protected software is to run on the device.

20. The arrangement of claim 12, wherein the enabling means and/or the identifying means are preferably provided by software elements associated with the protected software.

21. An arrangement for use in protection of software to be run on a wireless device operable for communication over a wireless network, the arrangement including:
authorisation means operable to receive an identifier characterising a device on which protected software is to be run, and the authorisation means being operable to execute a predetermined function on a received identifier to form a derived identifier, execution of the predetermined function being conditional upon verification of a condition required for authorisation of the use of the software; and to provide the derived identifier to allow enabling means to enable execution of the software only when in receipt of an enabling identifier which is a derived identifier derived from the identifier of the device on which the software is to be run.

22. The arrangement of claim 21, wherein the predetermined function is a function of at least two variables, a received identifier forming one of the variables, and another variable being a confidential decryption key stored at the authorisation means, wherein a preliminary step is required upon receipt of a derived identifier by enabling means, to execute a second predetermined function of at least two variables, including the identifier and the derived identifier, to recover the confidential decryption key for use as a decryption key in decrypting an encrypted form of the protected software.

23. The arrangement of claim 22, wherein the identifier includes information characterising the protected software, the server being operable to select a confidential decryption key corresponding with the identified software.

24. The arrangement of claim 21, wherein the authorisation means is operable to effect a financial transaction or credit check before allowing execution of the predetermined function.

25. Computer software which, when installed on one or more devices, is operable to provide a software protection arrangement for protecting software to be run on a wireless device operable for communication over a wireless network, the arrangement including:
identifying means operable to create an identifier which characterizes the device on which the protected software is to be run;
authorisation means operable to receive an identifier created by the identifying means to execute a predetermined function on a received identifier to form a derived identifier, execution of the predetermined function being conditional upon verification of a condition required for authorisation of the use of the software;
and the arrangement further comprising enabling means operable to enable execution of the protected software only when in receipt of an enabling identifier from the authorisation means, the derived identifier serving as an enabling identifier in the event that the derived identifier has been derived by the predetermined function from the identifier of the device on which the protected software is to be run.

26. Computer software which, when installed on one or more devices, is operable to provide a software protection arrangement including:
identifying means operable to create an identifier which characterizes the device on which the protected software is to be run;
enabling means operable to receive a derived identifier derived by authorisation means from the identifier created by the identifying means, and the enabling means being further operable to enable execution of the software only when in receipt of an enabling identifier, the derived identifier serving as an enabling identifier in the event that the derived identifier has been derived by the predetermined function from the identifier of the device on which the software is to be run.

27. A carrier medium for software which, when installed on one or more devices, is operable to provide a software protection arrangement for protecting software to be run on a wireless device operable for communication over a wireless network, the arrangement including:
identifying means operable to create an identifier which characterizes the device on which the protected software is to be run;
authorisation means operable to receive an identifier created by the identifying means to execute a predetermined function on a received identifier to form a derived identifier, execution of the predetermined function being conditional upon verification of a condition required for authorisation of the use of the software;
and the arrangement further comprising enabling means operable to enable execution of the protected software only when in receipt of an enabling identifier from the authorisation means, the derived identifier serving as an enabling identifier in the event that the derived identifier has been derived by the predetermined function from the identifier of the device on which the protected software is to be run.

28. The medium of claim 27, the medium being a memory device or a transmission medium on which the software is carried by a propagating signal.

29. A carrier medium for software which, when installed on one or more devices, is operable to provide a software protection arrangement including:
identifying means operable to create an identifier which characterizes the device on which the protected software is to be run;
enabling means operable to receive a derived identifier derived by authorisation means from the identifier created by the identifying means, and the enabling means being further operable to enable execution of the software only when in receipt of an enabling identifier, the derived identifier serving as an enabling identifier in the event that the derived identifier has been derived by the predetermined function from the identifier of the device on which the software is to be run.

30. The medium of claim 29, the medium being a memory device or a transmission medium on which the software is carried by a propagating signal.

31. A signal propagating on a transmission medium and carrying software which, when installed on one or more devices, is operable to provide a software protection arrangement for protecting software to be run on a wireless device operable for communication over a wireless network, the arrangement including:
identifying means operable to create an identifier which characterizes the device on which the protected software is to be run;
authorisation means operable to receive an identifier created by the identifying means to execute a predetermined function on a received identifier to form a derived identifier, execution of the predetermined function being conditional upon verification of a condition required for authorisation of the use of the software;
and the arrangement further comprising enabling means operable to enable execution of the protected software only when in receipt of an enabling identifier from the authorisation means, the derived identifier serving as an enabling identifier in the event that the derived identifier has been derived by the predetermined function from the identifier of the device on which the protected software is to be run.

32. A signal propagating on a transmission medium and carrying software which, when installed on one or more devices, is operable to provide a software protection arrangement including:
identifying means operable to create an identifier which characterizes the device on which the protected software is to be run;
enabling means operable to receive a derived identifier derived by authorisation means from the identifier created by the identifying means, and the enabling means being further operable to enable execution of the software only when in receipt of an enabling identifier, the derived identifier serving as an enabling identifier in the event that the derived identifier has been derived by the predetermined function from the identifier of the device on which the software is to be run.

33. A signal propagating on a transmission medium and carrying an identifier or derived identifier of a software protection arrangement for protecting software to be run on a wireless device operable for communication over a wireless network, the arrangement including:
identifying means operable to create an identifier which characterizes the device on which the protected software is to be run;
authorisation means operable to receive an identifier created by the identifying means to execute a predetermined function on a received identifier to form a derived identifier, execution of the predetermined function being conditional upon verification of a condition required for authorisation of the use of the software;
and the arrangement further comprising enabling means operable to enable execution of the protected software only when in receipt of an enabling identifier from the authorisation means, the derived identifier serving as an enabling identifier in the event that the derived identifier has been derived by the predetermined function from the identifier of the device on which the protected software is to be run.

34. A method of protecting software to be run on a wireless device operable for communication over a wireless network, including the steps of:
creating an identifier which characterizes the device on which the protected software is to be run;
receiving an identifier and executing a predetermined function on a received identifier to form a derived identifier, execution of the predetermined function being conditional upon verification of a condition required for authorisation of the use of the software;
and enabling execution of the protected software only in response to an enabling identifier, the derived identifier serving as an enabling identifier in the event that the derived identifier has been derived by the predetermined function from the identifier of the device on which the protected software is to be run.

35. The method of claim 34, wherein a function is applied to the derived identifier to recover the identifier from which the derived identifier was derived, and to compare the recovered identifier with the identifier created by the identifying means, and to enable or disable execution of the software in accordance with the result of the comparison.

36. The method of claim 34, wherein the protected software is in encrypted form requiring decryption by at least one decryption key for successful execution, the enabling step including a decryption step which includes decryption of the encrypted code, the derived identifier being used as a key for the decryption step.

37. The method of claim 34, wherein the predetermined function is a function of at least two variables, a received identifier forming one of the variables, and the other variable being a confidential decryption key, the enabling step including a preliminary step to execute a second predetermined function of at least two variables, including the identifier and the derived identifier, to recover the confidential decryption key for use as a decryption key in decrypting the encrypted code.

38. The method of claim 34, wherein the identifier is created to include information characterising the protected software, and the confidential decryption key is selected according to the software identified.

39. The method of claim 34, wherein the identifier is derived from information which identifies hardware and/or software present at the device.

40. The method of claim 34, wherein a financial transaction or credit check is effected before allowing execution of the predetermined function.
